(19) United States
(12) Patent Application Publication
(10) Pub. No.: US 2004/0070606 A1
(43) Pub. Date: Apr. 15, 2004

(54) Method, system and computer product for performing e-channel analytics

(76) Inventors: Dan Yang, Westborough, MA (US); Chistopher Donald Johnson, Clifton Park, NY (US); Richard Paul Messmer, Rexford, NY (US); Mark Stuart McKenzie, Ballston Spa, NY (US); Chandrasekhar Pisupati, Stamford, CT (US); Yu-to Chen, Pleasanton, CA (US)

Correspondence Address: General Electric Company, CRD Patent Docket RM 4A59, Bldg. K-1, P.O. Box 8, Schenectady, NY, 12301, US

(21) Appl. No.: 10/259,348

(22) Filed: Sep. 27, 2002

(51) Int. Cl. G09G 5/00

(52) U.S. Cl. 345/745

(57) ABSTRACT

In this disclosure there is a method, system and a tool for analyzing e-channel data for a website and for applying the analytics for obtaining a rule based personalized website. The e-channel data is obtained, pre-processed and integrated. Different analytics are performed on the integrated data and reports are generated. In addition, this disclosure describes a marketing association tool for extracting useful rules from the pre-processed data and using the rules for enhancing the website dynamically and for generating decision support reports.

### BACKGROUND OF THE INVENTION

This disclosure relates generally to e-commerce websites and more particularly to a method, system and computer product for analyzing information from an e-commerce website and applying it in a manner that yields optimal web site design and development.

Generally, e-commerce websites aim to increase sales for products and services through effective presentation of information about these products and services. Since face-to-face interaction of potential customers with sales or marketing personnel is not available in the e-commerce environment, the success of these websites depends on how effectively and creatively the website is able to hold the interest of these potential customers. The potential customers in the e-commerce environment are the website visitors who may have arrived at the website due to a variety of different reasons. The visitors generally have different socioeconomic backgrounds and therefore different requirements from the website. The issue becomes more complex since any commercial website would typically have information about multiple products and services; the details of each of these makes the information complex from the point of view of the visitors who may have interest only in a specific product or service or other interests in range of products, comparable pricing, availability etc.

It is therefore a challenge for website designers and the product or service marketing and management personnel to effectively deliver the right information at the right time to the right visitors, to increase the rate of return to the website by these visitors and eventually increase visitor satisfaction. Therefore, there is a need for an approach that would intelligently understand and interpret visitor behavior and facilitate the website designers and product personnel to take informed decisions for improving the quality and contents of the website.

### BRIEF SUMMARY OF THE INVENTION

In one embodiment of this disclosure, there is a method, system and a computer readable medium that stores computer instructions for instructing a computer system to analyze e-channel data for a website. In this embodiment, a plurality of e-channel data is obtained; pre-processed and integrated. In addition, analytics are performed on the c-channel data and then analytic reports are generated based on the analytics.

In a second embodiment of this disclosure, there is a method, system and computer readable medium that stores instructions for instructing a computer system to apply analytics for a website. In this embodiment, a plurality of e-channel data is obtained; pre-processed and integrated. Then analytics are performed on the e-channel data and analytic reports are generated based on the analytics. The analytics are used to obtain a rule based personalized website.

In a third embodiment of this disclosure, there is a marketing association analysis tool for a website. The marketing association analysis tool comprises a pre-processing component for pre-processing the plurality of e-channel data; an association rule discovery engine for generating an output, where the output comprises rules based on the pre-processed data; and a post-processing component for applying a pre-determined criterion on the output of the association rule discovery engine for extracting useful rules.

In a fourth embodiment of this disclosure, there is a system for analyzing e-channel data for a website. In this embodiment, there is an e-channel data input source that obtains a plurality of e-channel data. There is a marketing association analysis tool that comprises a pre-processing component that preprocesses the e-channel data. The marketing association analysis tool also comprises an association rule discovery engine for generating an output, wherein the output comprises rules based on the pre-processed data. In addition, the marketing association analysis tool comprises a post-processing component for applying a pre-determined criterion on the output of the association rule discovery engine for extracting useful rules. The system also comprises a decision support report component that generates reports using the useful rules extracted by the marketing association analysis tool.

### BRIEF DESCRIPTION OF THE DRAWINGS

FIG. 1 shows a schematic of a general-purpose computer system in which a method and a tool that analyzes e-channel data and applies analytics for a website operates

FIG. 2 shows a top-level component architecture diagram of a system for analyzing e-channel data and that operates on the computer system shown in FIG. 1;

FIG. 3 shows a flow chart describing the method for analyzing the e-channel data used in the system of FIG. 2;

FIG. 4 shows a schematic of a pre-processing component used in the system of FIG. 2;

FIG. 5 shows a flow chart describing one of the methods of preprocessing e-channel data for visit path analysis;

FIG. 6 shows a flow chart describing the method for performing analytics to identify broken links for a website;

FIG. 7 shows an example of a web page having a broken link in a website;

FIG. 8 shows the results of applying Capri, a sequential discovery algorithm for identifying broken links, as an example of performing analytics;

FIG. 9 shows a flow chart describing the method for performing analytics with a decision tree approach that discovers user preferences and user profiling;

FIG. 10 shows an example of using a decision tree approach to do analytics to find out who is interested in getting special loan interest information;

FIG. 11 shows sample reports from the report component of FIG. 2;

FIG. 12 shows a top-level component architecture diagram of a system for applying analytics based on e-channel data and delivering a rule based dynamic website;

FIG. 13 shows a flowchart describing the method for delivering a rule based dynamic website of FIG. 12;

FIG. 14 shows a schematic of a marketing association analysis tool for a website that supports decision making and adds value to the web content of the website; and

FIG. 15 shows a schematic of a system in which the methods and systems described in FIGS. 1-14, for analyzing e-channel data and applying analytics for a website can operate.

### DETAILED DESCRIPTION OF THE INVENTION

In this disclosure, there is a description of a method, system and computer product that analyzes e-channel data and applies analytics to give a variety of outputs which can be used for further website design and development. In addition, the analytics can be used to convert more visitors into customers by providing customers with preferred products, high quality contents and value added services on the site. Through the analytics, different stakeholders which may include product or company management personnel, marketing personnel, or web site designers, are able to take steps to retain more valuable customers by calculating customer lifetime value and improving e-customer relationship management.

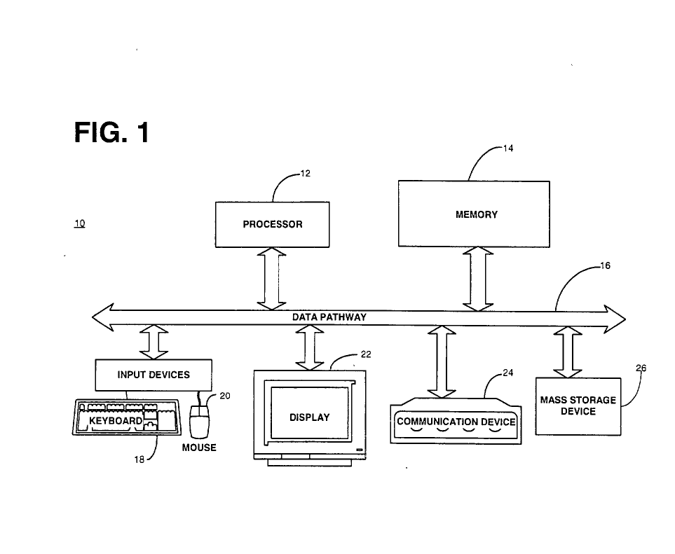

As an example, this approach for analyzing e-channel data can be implemented in software. FIG. 1 shows a schematic of a general-purpose computer system 10 in which a sub-system that analyzes e-channel data and applies analytics for a website operates. The computer system 10 generally comprises at least one processor 12, a memory 14, input/output devices, and data pathways (e.g., buses) 16 connecting the processor, memory and input/output devices. The processor 12 accepts instructions and data from the memory 14 and performs various calculations. The processor 12 includes an arithmetic logic unit (ALU) that performs arithmetic and logical operations and a control unit that extracts instructions from memory 14 and decodes and executes them, calling on the ALU when necessary. The memory 14 generally includes a random-access memory (RAM) and a read-only memory (ROM); however, there may be other types of memory such as programmable read-only memory (PROM), erasable programmable read-only memory (EPROM) and electrically erasable programmable read-only memory (EEPROM). Also, the memory 14 preferably contains an operating system, which executes on the processor 12. The operating system performs basic tasks that include recognizing input, sending output to output devices, keeping track of files and directories and controlling various peripheral devices.

The input/output devices may comprise a keyboard 18 and a mouse 20 that enter data and instructions into the computer system 10. Also, a display 22 may be used to allow a user to see what the computer has accomplished. Other output devices may include a printer, plotter, synthesizer and speakers. A communication device 24 such as a telephone or cable modem or a network card such as an Ethernet adapter, local area network (LAN) adapter, integrated services digital network (ISDN) adapter, or Digital Subscriber Line (DSL) adapter, that enables the computer system 10 to access other computers and resources on a network such as a LAN or a wide area network (WAN). A mass storage device 26 may be used to allow the computer system 10 to permanently retain large amounts of data. The mass storage device may include all types of disk drives such as floppy disks, hard disks and optical disks, as well as tape drives that can read and write data onto a tape that could include digital audio tapes (DAT), digital linear tapes (DLT), or other magnetically coded media. The above-described computer system 10 can take the form of a hand-held digital computer, personal digital assistant computer, notebook computer, personal computer, workstation, mini-computer, mainframe computer or supercomputer.

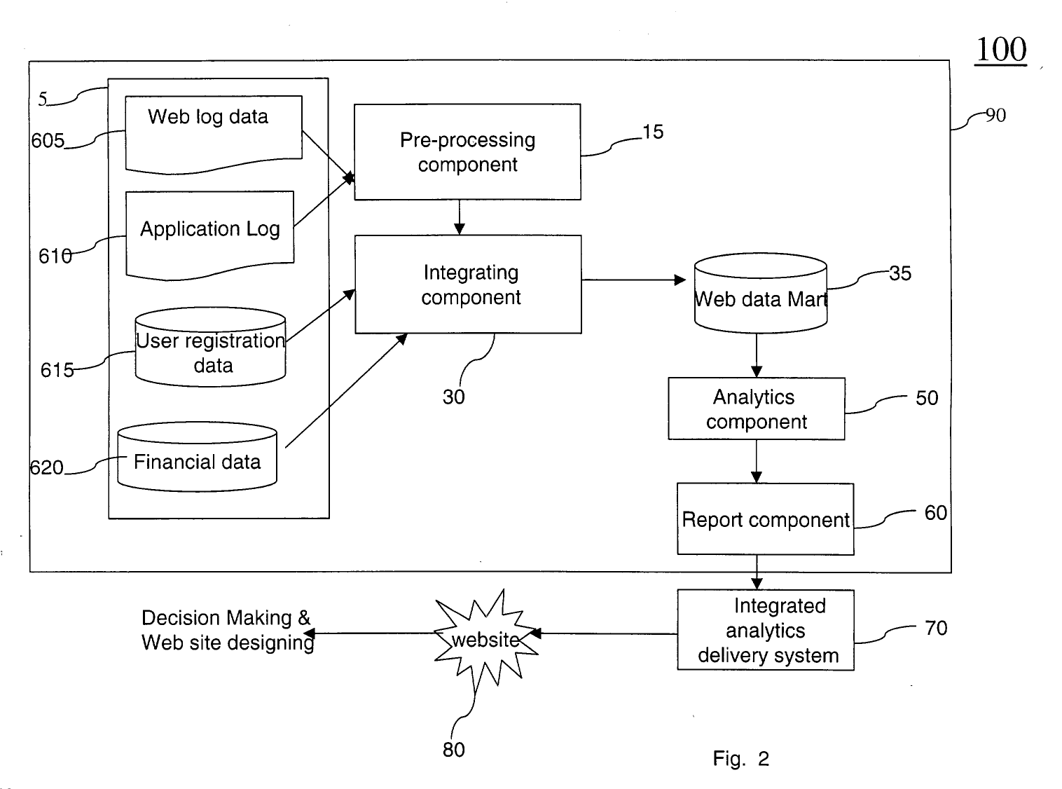

FIG. 2 shows one embodiment of the disclosure through a top level component architecture diagram of a system 100 for analyzing e-channel data that operates on the computer system 10 shown in FIG. 1. The system 100 comprises a sub-system 90 which comprises an e-channel data input source 5 that contains a variety of e-channel data including web log data 605, application log data 610, user registration data 615 and financial data 620. Besides the web and application log data there are other useful e-channel data resources like user registration data 615 containing a visitor's personal data and financial data 620 containing information on financial transactions. It must be appreciated that there can be other data resources such as sales data that may provide useful information. The web log data 605 and the application log data 610 are sent to a data pre-processing component 15 for extracting useful information from the web and application log data. The output from the data pre-processing component 15, user registration data 615 and financial data 620 (and any other useful data resources) are integrated in a data integration component 30. Here, the data from multiple data resources is merged by using a predefined visitor identifier. The integrated e-channel data is then sent to a web data mart 35 for storage. An analytics component 50 uses the contents in the web data mart 35 to perform multiple analytics for achieving website enhancements that yield a set of reports which are generated in a report component 60. The system 100 further comprises an integrated analytics delivery system 70 which delivers the results from the report component 60 to a website 80. These reports are sent over the Internet (World Wide Web) to a website 80 to be read by interested stake holders who need to read the report for taking business decisions.

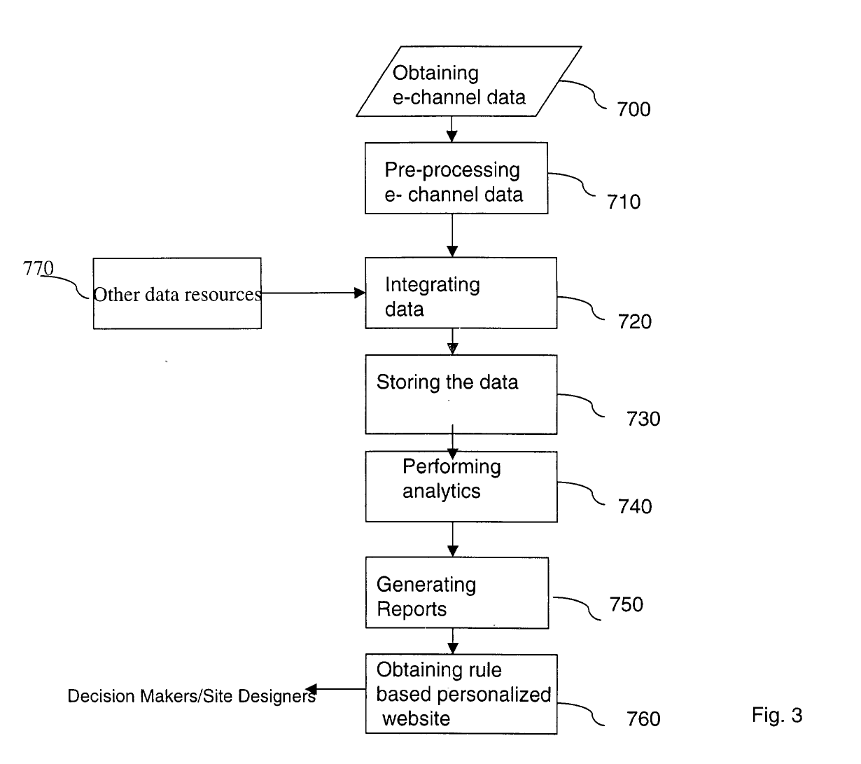

FIG. 3 shows a flowchart describing the method for analyzing the e-channel data used in the system of FIG. 2. The method includes obtaining a plurality of e-channel data at 700. E-channel data is created when a visitor browses a website and can be obtained by getting access to the logged information, which is a record of instructions in a network protocol created as the visitor is browsing through the website. The next step in the method includes preprocessing the c-channel data according to analytical method requirements at 710. Different analytical methods require different type of pre-processing. For example, for path analysis, visit sessions need to be identified and sessions with only one page hit need to be eliminated. On the other hand, for website usage analysis, pre-processing is not required. The next step involves integrating the e-channel data at 720 where the data from various data sources is merged. One example illustrating the integration of other data resources is shown at 770 which could include a company's internal data about a customer and any external data. The method further includes storing the e-channel data in a web data mart at 730. The next step involves performing analytics on the e-channel data at 740 and generating analytic reports based on the analytics at 750. In a specific example the results from the reports are sent to the website which enables in generating a rule based website at 760. This is a dynamic website where contents and look of the website is continuously adapted to customers' or visitors' needs (e.g., rules are extracted from the various analytics performed and communicated in reports). Below is a more detailed discussion of the elements shown in FIG. 2 and the steps shown in FIG. 3.

As stated hereinabove the e-channel data comprises at least one of web log data 605, application log data 610, user registration data 615 and financial data 620. The web log data 605 is a record of all events occurring on the web server. Typically, the web log data 605 is generated automatically by the web server. It contains a visitor address, visit time, visiting site object and operation, status code and message size. The visitor address is represented by TCP/IP address of the website visitor. This information is used to identify one visit session from a visitor/customer. The visiting site object and operation indicate the page visited and the information sent by the visitor (e.g., a visitor sends information to the website using a web form). This information is useful to identify what parts of the website are visited by the visitors and is further useful to construct the visiting paths of the visitors. Status code is an integer that represents the status of the visit as successful or failed. This information is useful in identifying broken links or missing resources like images. Message size is an integer representing the size of a visited page or resources. The application log data 610 records the important events on the site collected by the site application system. The format depends on the system and in one example, this data is captured and stored in a relational database like Oracle 8. The user registration data comprises personal data of a visitor. The personal data of the visitor comprises at least one of age, gender, job and geographical area. The financial data comprises at least one of sales data and transaction data. Other kinds of e-channel data like customer equipment advertisement, equipment searching/viewing, equipment requesting posting can also be leveraged.

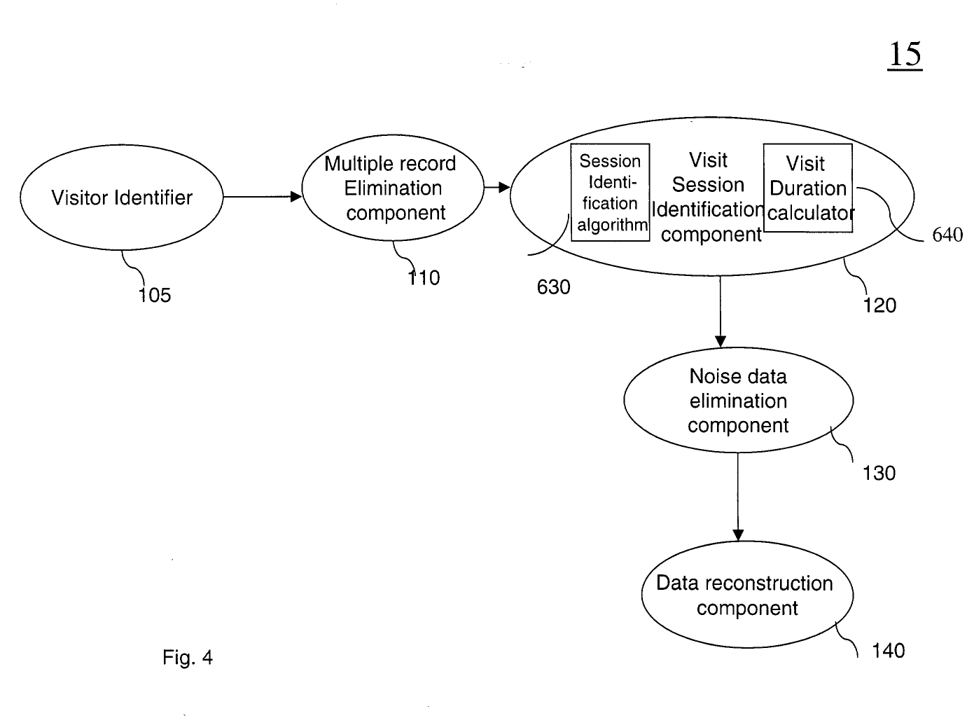

FIG. 4 shows an exemplary schematic of the pre-processing component 15 used in FIG. 2. The pre-processing component 15 comprises a visitor identifier component 105 where visitor identifiers are used for reconstruction of a visit session. The visitor identifier component 105 is linked to a multiple record elimination component 110 where multiple records for a single page hit are eliminated. The multiple record elimination component 110 is linked to a visit session identification component 120 which comprises visit session identification algorithms 630 and visit duration calculator 640 for identifying a visit session from an individual page hit information. Below is a more detailed discussion of visit session identification algorithms and a visit duration calculator. The visit session identification component is linked to a noise data elimination component 130 where noise data is eliminated and the output is sent to a data reconstruction component 140 where the visit data path is reconstructed.

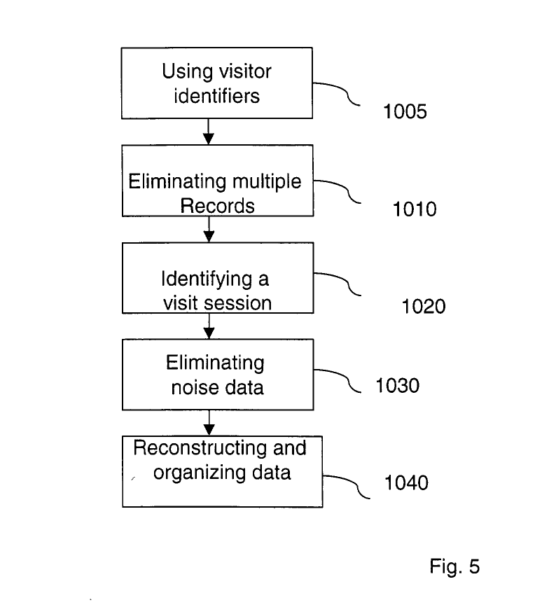

FIG. 5 shows a flow chart describing the method for pre-processing e-channel data for visit path analysis. The method involves using visitor identifiers for reconstructing a visit session and visit history at 1005. The next step involves eliminating multiple records from the reconstructed visit session and visit history for an individual page hit at 1010. The next step is identifying a visit session from the individual page hit information at 1020 and then eliminating noise data occurring in the visit session at 1030 and producing an output. The last step involves reconstructing the visit data using the output from the noise data elimination step and website domain knowledge at 1040. Below is a more detailed discussion of each the steps shown in the flow chart of FIG. 5.

Visitors' identifiers are used to construct visit sessions and the history of the visits. There are three kinds of visitor identifiers. The first kind is a TCP/IP address. These are easy to get and exist in each entry of web log file. Most computers connected to the Internet have their own TCP/IP address. Therefore TCP/IP address is used as unique identifier for most visitors. However, some visitors are behind corporate firewalls, so visitors coming from one firewall share the same TCP/IP address. To uniquely identify these visitors, the web server sends a unique string to each visitor's machine. These unique strings are the second kind of visitor identifier and are called cookies. When visitors visit the website, the web server fetches the cookies on the visitors' machine and puts them in log files. The third kind of identifier is the login name of the visitor. When visitors login to a website, their login names are obtained and put in a log file.

The next step is eliminating multiple records at 1010. In a log file, one visit to a page is recorded as multiple entries. Each entry records an access to an object in the page. These objects include the page itself, the images, sounds and other resources included in the page. This step eliminates multiple entries for a one page hit and only retains one entry for a session identification. A session is defined as a period when a visitor visits the website one time. The session is composed of a sequence of his/her visits to multiple pages during this period. Due to the nature of HTTP protocol, it is difficult to identify the time when a visitor leaves a page. Therefore, identifying of a visit session comprises using session identification algorithms 630 to reconstruct the visit session from a web log and using the time difference of two consequent page visits for calculating the duration of the visit in a visit duration calculator 640.

As mentioned above, the session identification algorithms sort all records by the visitor identifier as described hereinabove. This enables all the records of one visitor to be arranged together. In addition, the session identification algorithms consolidate multiple records for one page into one by eliminating entries to access resources other than a HTML web page. To achieve these objectives, the session identification algorithms perform the following steps until the end of the web log records is reached. The process starts with initialization, where a page hit is represented by the first record of a visitor identifier. Next a record is obtained from the web log records. If it is the end of the web log records for the current visitor identifier, then this visit session is concluded and then visit sessions are reconstructed for a new visitor identifier. If it is not the end of the web log records for the current visitor identifier, the record is put as the second of two consecutive records. For two consecutive records, the duration of the visits is calculated in a visit duration calculator 640 using time stamps of the records. Time stamps are described in detailed below. If the time difference is smaller than the threshold e.g., 30 minutes, the page represented by the second record is added to the current session. The second record is used as the first of the next two consecutive records. If the time difference is greater than the threshold, it marks the end of the current session. The second record is set for initialization.

As discussed hereinabove there are time stamps associated with each log record. The duration is calculated by transferring the time stamps in the format of ‘Year: Month: Day: Hour: Minutes’ and secondly, into a number that is the internal representation of the time (e.g. Jan. 1, 1990 is used as the start point, the number of seconds of current time stamps to the start point are calculated, and the number is used as the internal representation of the time stamps). The internal time representation of the second record is subtracted from the first to get duration. The duration is translated into a unit consistent with the threshold (e.g. minutes).

The next step in FIG. 5 is eliminating noise data. The definition of noise data is dependent upon the analytics being performed. For example in the visit path analysis, if a session has only one page, it represents that the visitor just hits one page and exits. Such a session does not provide value in path analysis, and thus is counted as noise and eliminated. The next step in FIG. 5 involves reconstructing and organizing the data. In this step, multiple frames of one page and hierarchical structure of the website design are integrated to refine visit sessions identified at 1020. For example, visits of multiple pages can be organized into one category according to the content structure of the website. Another example is to compare a fragment of the identified visit session with website page linkages. If the fragment of the visit session indicates browsing a subset of the site linkage structure, then the fragment is considered to be a visiting path from the same visitor. The preprocessed data is then integrated in the data integrating component 30.

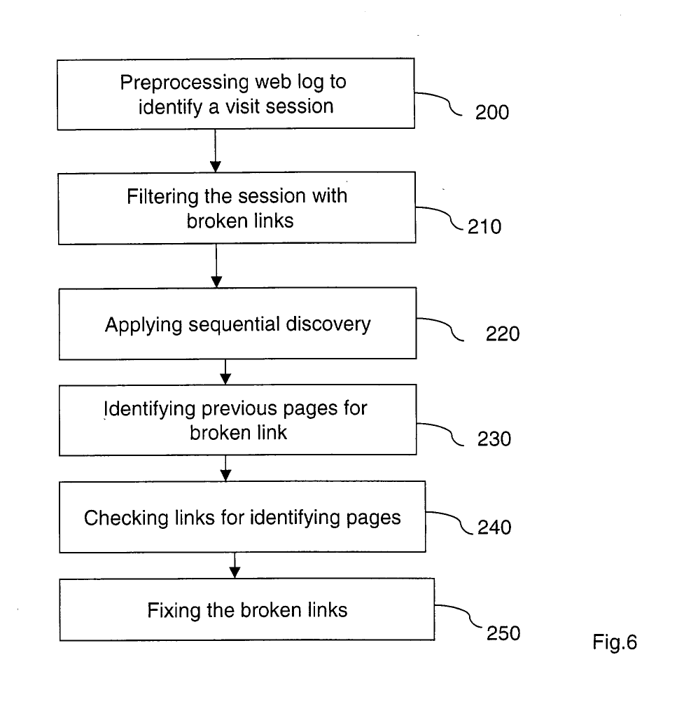

One example of analytics that are performed on the e-channel data is identifying broken links in the website to increase website quality. FIG. 6 shows a flow chart that describes the method of identifying broken links in a website. As shown in the flow chart of FIG. 6, identifying broken links comprises preprocessing web log data to identify a visit session at 200; filtering a plurality of visit sessions having broken links at 210; applying a sequential discovery application at 220 to find a common path leading to the broken link; identifying previous pages having the broken link at 230; checking links for the identified pages at 240; and fixing the broken link at 250. Below is a more detailed discussion of each the steps shown in the flow chart of FIG. 6.

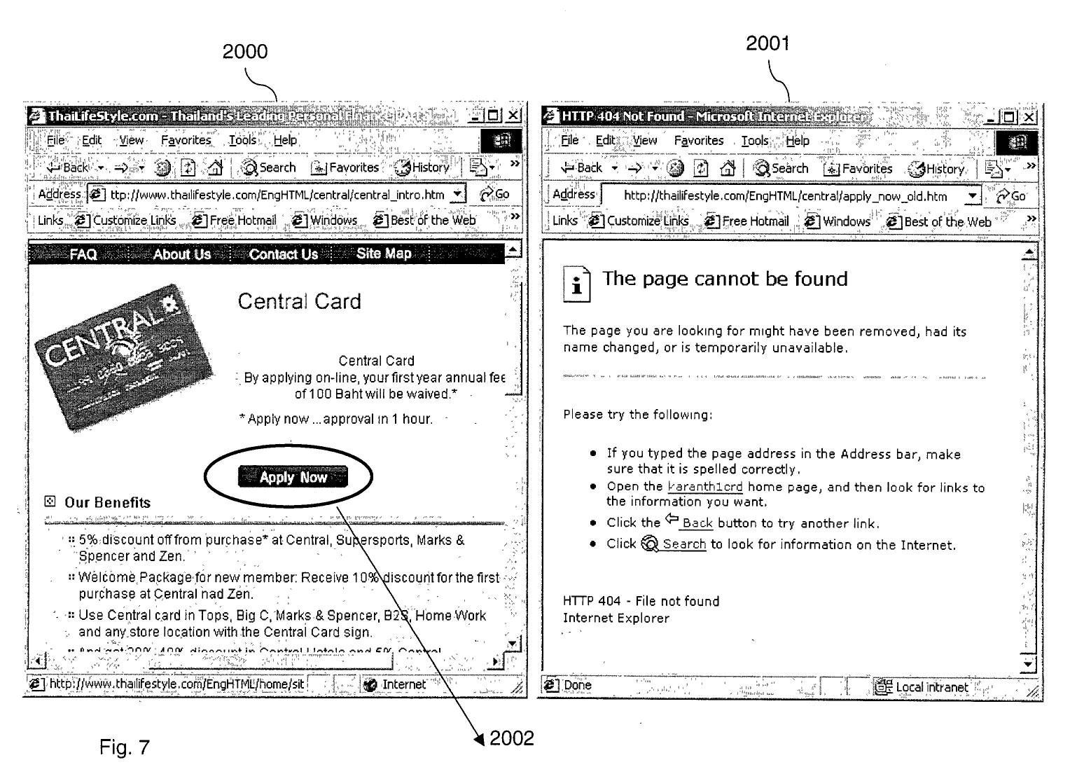

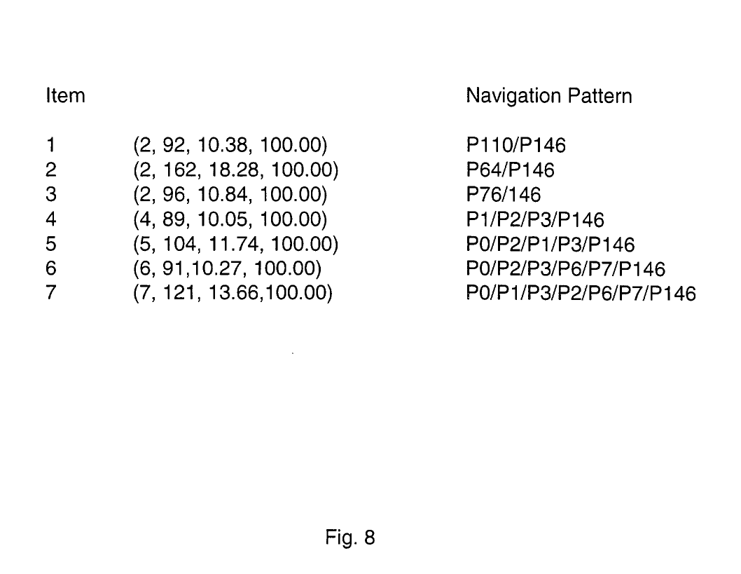

FIG. 7 shows an example of a broken link in a website. The button “Apply Now” 2002 in the first page 2000 is linked to a page not existing in the server any more. If a visitor clicks on this button, a second page 2001 is generated with an error message as shown. Therefore, the first page contains a broken link. In particular, this example shows that the link to a central card application form is broken. This means that instead of viewing application forms, the visitors get error messages when they click on this link as illustrated by 2001 in FIG. 7. To fix this problem, critical paths in which the broken links are embedded are located. To do this, the steps for identifying broken links which have been discussed hereinabove are applied, as is Capri, a sequential discovery algorithm for identifying a common path. One of the results of identifying broken links through Capri is shown in FIG. 8. In FIG. 8, the notation P* is used, where* is an integer that represents an encoded page. For example, P110/P146 in FIG. 8 represents a navigation pattern where page P110 is followed by page P146. Item 1 in FIG. 8 represents that P110/P146 is a common path for all sessions. Item 1 is characterized by having 2 pages and appears 92 times among all the sessions. In addition, Item 1 accounts for 10.38% of all sessions. Among all sessions in which page P110 appears, 100% of them have the next page as P146. P7 is known as the broken link in this example. It is found in the two most common navigation paths (Items 6 and 7). In both patterns, the page before page P7 is page P6 and from that the broken embedded links are found and then fixed.

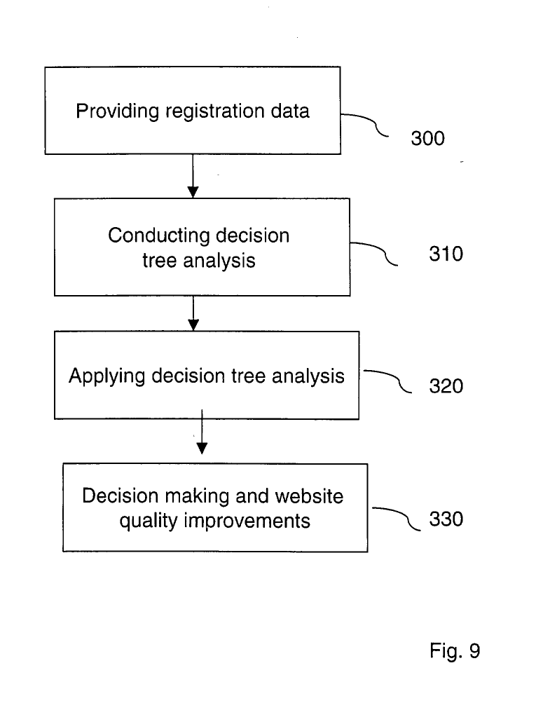

Another example of analytics that are performed in this disclosure is discovering preferences of a visitor and visitor profiling as shown in FIG. 9. Discovering preferences of a visitor and visitor profiling comprise providing registration data for collecting visitor preferences at 300; conducting a decision tree analysis to analyze visitor preferences at 310; applying an association tree analysis for discovering associations at 320; and using results of the decision tree analysis and association tree analysis for decision making and website quality improvements at 330. Below is a more detailed discussion of each of the steps shown in the flow chart of FIG. 9.

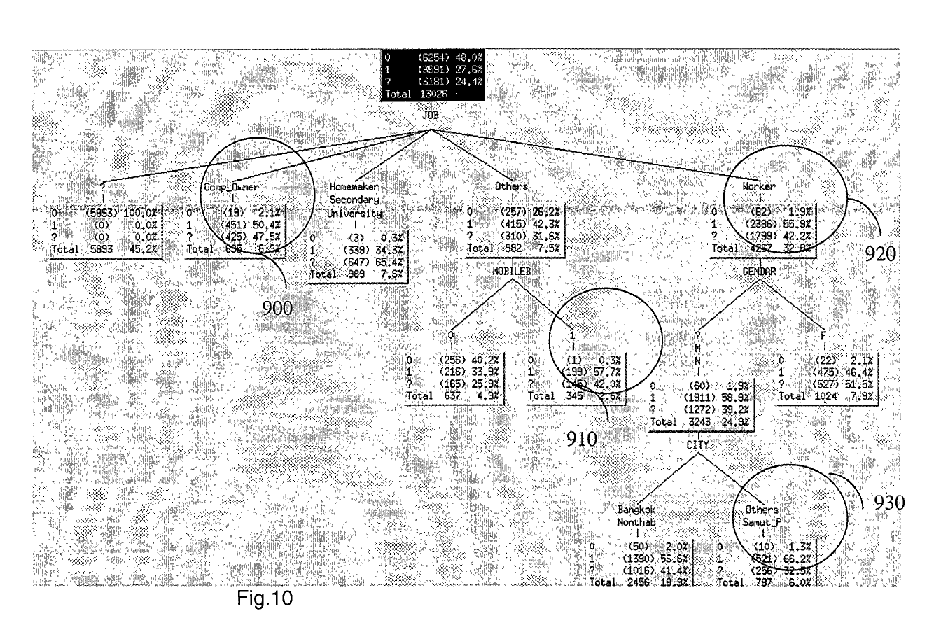

FIG. 10 shows one example of a decision tree approach that is used to find out a subgroup of visitors who are more interested in getting special loan information compared with all of the population in a specific category. Each block in the tree contains the following information:

The total number of people in this category. For example the root block represents that there are 13026 people in total.

The number and the percentage of people who are not interested (labeled with 0) in getting special loan interest information out of the total people in this category. For example the root block represents that there are 6254 people who are not interested in getting special loan interest information out of 13026. They account for 48.0% of total population in this category.

The number and the percentage of people who are interested (labeled with 1) in getting special loan interest information out of total people in this category. For example the root block represents that there are 3591 people who are interested in getting special loan interest information out of 13026. They account for 27.6% of total population in this category.

The number and the percentage of people whose attitudes are not known (labeled with ?) in getting special loan interest information out of the total people in this category. For example the root block represents that there are 3181 people whose attitudes in getting special loan interest information are unknown out of 13026. They account for 24.4% of total population in this category.

The block with two or more lower level branch blocks represents that the people in that block are divided into subgroups according to an attribute. For example, the people in the root block are divided into 5 subgroups according to their “job”; here “job” is the attribute dividing all people into subgroups.

The block with upper level blocks represents that it is a subgroup of the upper level blocks and the label listed above the block is an attribute of this subgroup. For example, the third branch of the root block represents the subgroup of people whose job is ‘homemaker’, or ‘staff in secondary schools and universities’.

The objective of this analysis is to identify a subgroup of people out of the total population visiting the website who are interested in get special loan interest information. This is accomplished by comparing the percentage of the people who are interested in getting special loan interest information with that of all the population, which is the 27.6% according to the number in the root block. Based on the above information, the analysis at block 900 shows that more workers and company owners are interested in getting special loan interest information from the site. Block 920 shows that amongst the workers, more than half (66%) are of the female gender and are interested in special loan information. When the gender is not known, and geographical area is considered, people in ‘others and Samut_P region’ at block 930 are more interested in the loan. Block 910 shows that in the ‘other’ job category, more people (57.7%) with mobile phones are interested in getting special loan information.

In this disclosure, various kinds of analytical methods can be used to perform analytics. Univariate analysis, multivariate analysis, association analysis and decision tree analysis are a few illustrative, but non-exhaustive list of examples of analytical methods in the increasing order of algorithm complexity and decreasing order of knowledge gained and analytical effort. For example, association analysis has the highest algorithm complexity, but at the same time the association analysis is the easiest and more information is gained through it.

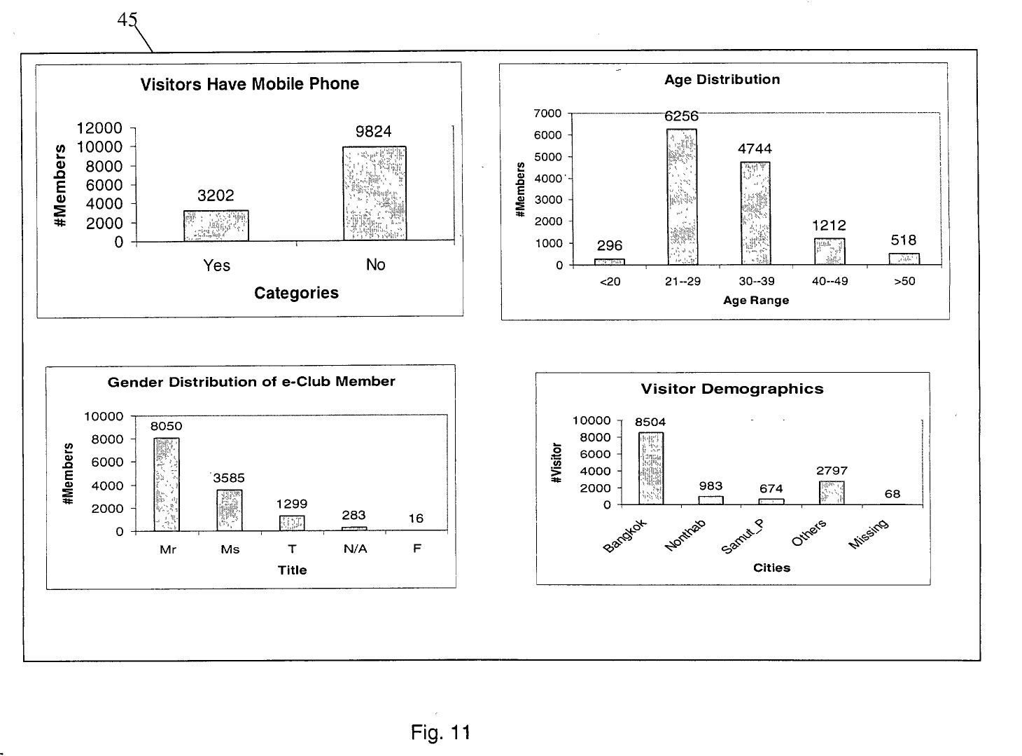

After performing the desired analytics, different varieties of analytics reports 45 are generated. FIG. 11 shows some exemplary reports. These reports 45 comprise at least one of a web usage report, customer profiling report and visitor navigation report. The web usage report comprises at least one of a daily usage summary, hourly usage summary and requests to a directory. The web usage report may also include statistics on the number of visitors, unique visitors/repeat visitors, page viewed, objects downloaded, and information on broken links. The customer profiling reports are generated from user registration data. Customer segmentation reports are generated on the basis of how long and how frequent a customer navigates the site. It is also based by the preference of customers for products/site topics. The visitor navigation report uses sequential discovery to find common visiting paths (i.e., most popular path or pages) that the visitors navigate through. The reports 45 could be generated automatically or semi-automatically. The reports 45 facilitate decision making on a variety of aspects. For example, the reports can be used to determine what kind of products are more attractive for a website, which customers a website should try to focus on for long-term relationships, and improve the website quality.

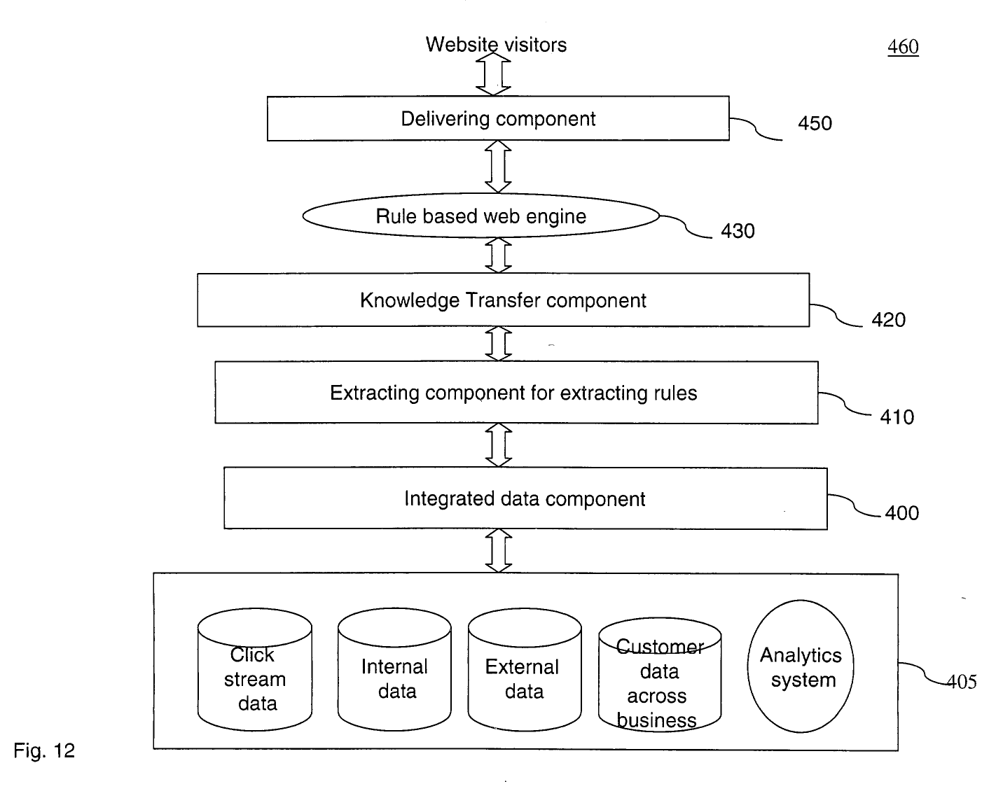

Another embodiment of the disclosure comprises obtaining a rule based personalized website. FIG. 12 shows an architecture diagram of a system 460 for applying analytics based on e-channel data to deliver a rule based dynamic website. The system 460 comprises using a plurality of data sources 405 which include click stream data and other e-channel related data, internal data about customers, external data such as demographic data and competitive marketing information, company-wide customer knowledge data such as sales, transaction, service and call center data and data from an analytics system. The data source 405 interacts with the integrated data component 400 that performs similar functions as the integrating component 30 discussed hereinabove and a data mart may be used to integrate the data and for embedding real time queries. The integrated data component 400 interacts with an extracting component 410 that is used to extract useful rules from the integrated data and dynamic visitor behavior. Dynamic visitor behavior includes information on the navigational paths used by them, duration of their visit sessions, product preferences and similar customer related information. The knowledge extracting component learns from the data and extracts the rules in real time. The extracting component 410 interacts with a knowledge transfer component 420 for transferring knowledge gained from extracted rules to a rule based web engine 430. The rules are interpreted in the rule based web engine, which interacts with a delivering component 450 for delivering dynamic contents to the website visitors.

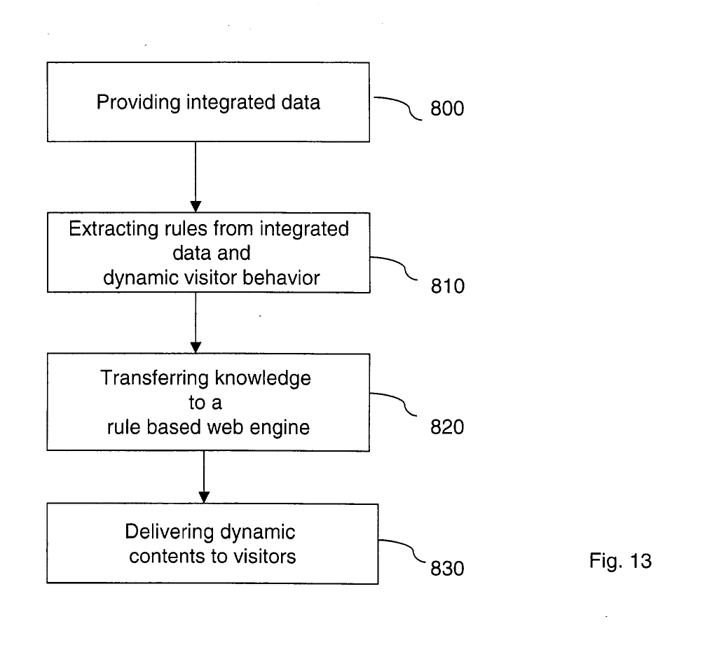

FIG. 13 shows a flowchart describing the method for delivering a rule based website of FIG. 12. This method comprises providing integrated data from a plurality of data sources at 800. In particular, the data from multiple data sources like click stream data, internal data, external data, customer data and analytics data is integrated at 800. The next step involves extracting rules from the integrated data and dynamic visitor behavior at 810. The knowledge from the extracted rules is transferred to a rule based web engine in the next step at 820. The final step involves delivering dynamic contents to visitors at 830.

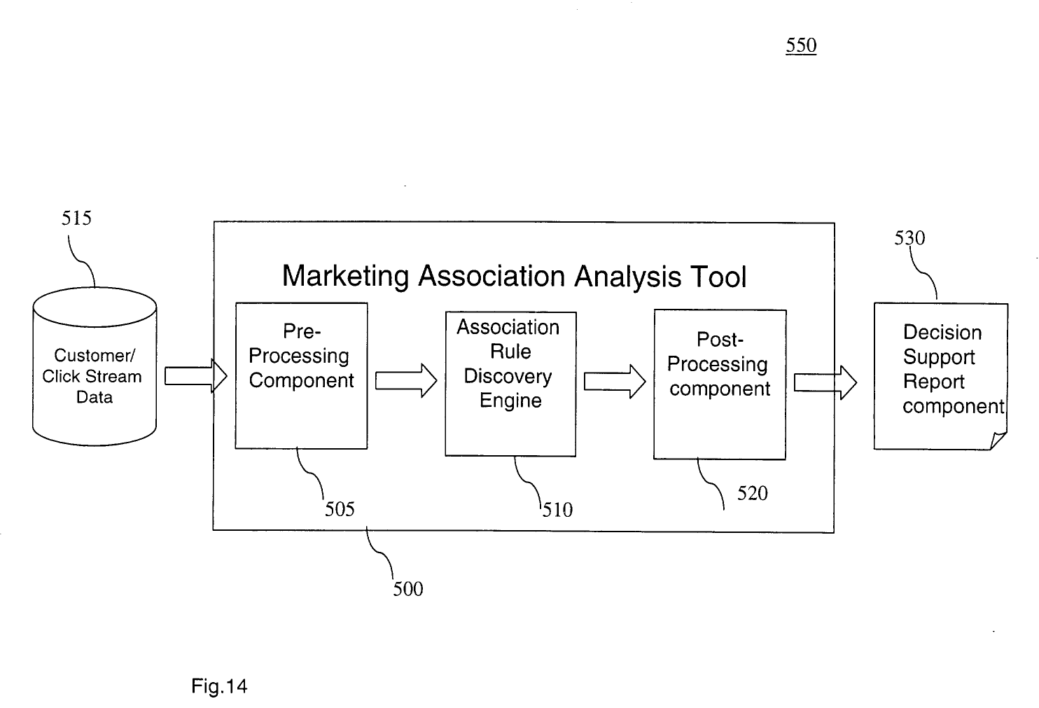

In another embodiment of the disclosure, there is a marketing association analysis tool 500 as shown in FIG. 14. The tool 500 comprises a preprocessing component 505 for pre-processing a plurality of e-channel data, where the e-channel data includes at least customer and click stream data; an association rule discovery engine 510 for generating an output, where the output comprises rules based on the pre-processed data; and a post-processing component 520 for applying a pre-determined criterion on the output of the association rule discovery engine 510 for extracting useful rules. The rules are used for generating useful information (e.g., decision support reports) for timely and cost-effective decision making and adding value in the web contents 530. Below is a more detailed discussion of each of the elements shown in FIG. 14.

The pre-processing component 505 performs a similar function as discussed hereinabove in relation with 15 of FIG. 2. The association rule discovery engine 510 is capable of discovering several association relationships among the variables generated from the pre-processing component. Amongst these relationships, there will be a select few relationships which will be of interest to the stakeholders—website designers or marketing/management personnel. In the post-processing component, the business domain knowledge is used to filter out useful and actionable rules of interest to the stakeholders. Some examples of the post processing criteria include ‘whether a rule uncovers an unexpected fact’. As an example, using the GE Thailifestyle website (i.e., Thailifestyle.com), it is not a surprise to see that people interested in CDs are also interested in books. But it would be unexpected if the rule finds that people who visit a flower site also visit an automobile financial site. Therefore, interesting rules which are selected include predefining product group/site domain groups based on business knowledge and if the association rule finds an association relationship across groups, it is a potentially unexpected fact. An example of post-processing criterion can be based on business objectives of a website. For example, GE's Thailifestyle.com website is primarily a financial site. In order to attract more visitors, some products, such as flowers, CDs, books are also sold online. In this case, a rule that discovers that people who visit the book site also visit the CD site is of less importance to the stakeholders compared with a rule that discovers that people who visit the flower site also visit the auto finance site. The later rule can be used for modifying the website for attracting more visitors to the financial product which is the main product promoted by the website. This can be achieved by selecting all the rules that include the auto finance product.

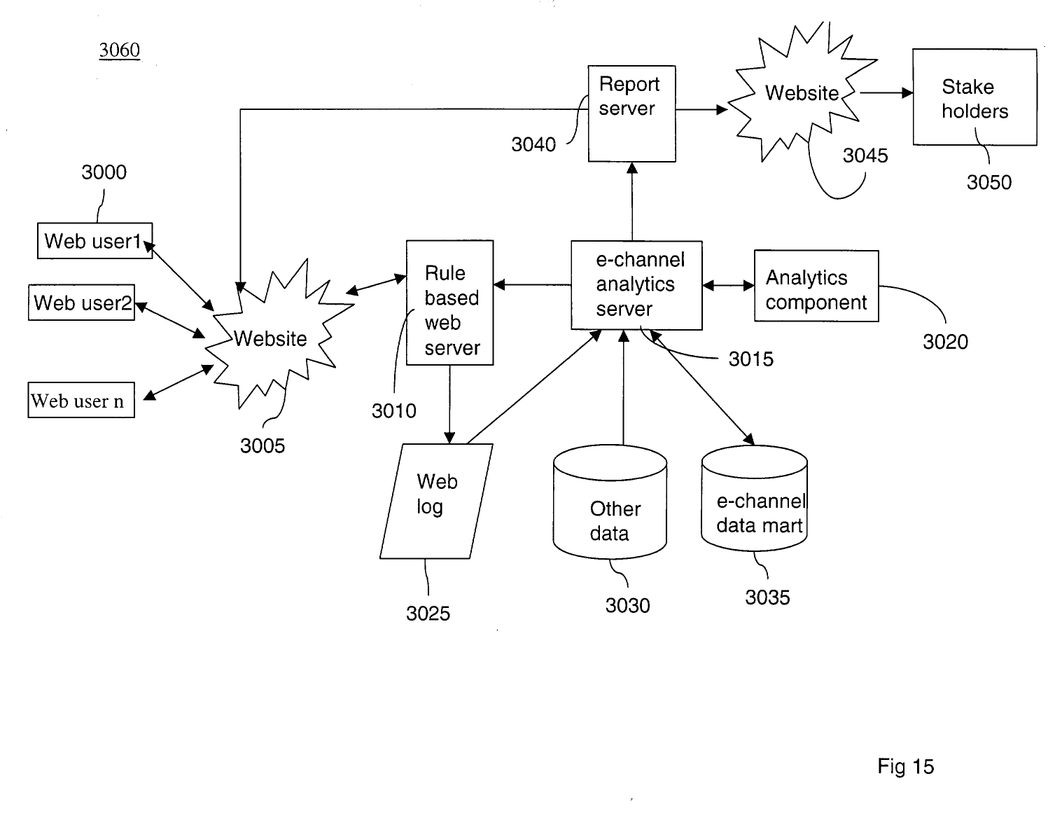

FIG. 15 shows a schematic of a system 3060 in which the methods and systems for analyzing and applying e-channel analytics described hereinabove can operate. In this embodiment, multiple web users (visitors) 3000 access a website 3005 through the World Wide Web. The website 3005 interacts dynamically with a rule based web server 3010. Thus, the website is able to project dynamic contents based on rules derived from visitors' attributes and behaviors through the rule based web server 3010. A web log 3025 is generated by the rule based web engine 3010 when the web users access the website. In addition, there is other data 3030 which is available to the proprietor of the website that can be used for performing analytics. For example, the other data 3030 can be financial and sales transaction data. The web log and the other data are pre-processed and merged to extract useful information at an e-channel analytics server 3015 and the results are stored into an e-channel data mart 3035. The e-channel analytics server 3015 interacts with the data in the e-channel data mart 3035 and conducts a variety of analytics at an analytics component 3020 in the manner discussed in the embodiments hereinabove. The analytical results from the e-channel analytics server 3015 are sent to a report server 3040 as reports. The results can also be sent to the rule based web server 3010 as rules for generating dynamic contents on the website. The reports from the report server 3040 can be accessed by interested stakeholders at 3050 through a special website 3045 meant for communication with the stakeholders, for internal reviews and business decision making. The reports can also be sent to website 3005 with access restrictions to serve as a tool for e-customer development.

The foregoing flow charts of this disclosure show the functionality and operation of the method, system and tool. In this regard, each block/component represents a module, segment, or portion of code, which comprises one or more executable instructions for implementing the specified logical function(s). It should also be noted that in some alternative implementations, the functions noted in the blocks may occur out of the order noted in the figures or, for example, may in fact be executed substantially concurrently or in the reverse order, depending upon the functionality involved. Also, one of ordinary skill in the art will recognize that additional blocks may be added. Furthermore, the functions can be implemented in programming languages such as C++ or JAVA; however, other languages can be used such as Perl, Javasript and Visual Basic.

The various embodiments described above comprise an ordered listing of executable instructions for implementing logical functions. The ordered listing can be embodied in any computer-readable medium for use by or in connection with a computer-based system that can retrieve the instructions and execute them. In the context of this application, the computer-readable medium can be any means that can contain, store, communicate, propagate, transmit or transport the instructions. The computer readable medium can be an electronic, a magnetic, an optical, an electromagnetic, or an infrared system, apparatus, or device. An illustrative, but non-exhaustive list of computer-readable mediums can include an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical).

Note that the computer readable medium may comprise paper or another suitable medium upon which the instructions are printed. For instance, the instructions can be electronically captured via optical scanning of the paper or other medium, then compiled, interpreted or otherwise processed in a suitable manner if necessary, and then stored in a computer memory.

It is apparent that there has been provided in accordance with this invention, a method, system and computer product that analyzes e-channel data and applies analytics to obtain useful information for website improvements and business decision making. While the invention has been particularly shown and described in conjunction with a preferred embodiment thereof, it will be appreciated that variations and modifications can be effected by a person of ordinary skill in the art without departing from the scope of the invention.

What is claimed is:

1. A method for analyzing e-channel data for a website, comprising:
obtaining a plurality of e-channel data;
pre-processing the e-channel data;
integrating the e-channel data;
performing analytics on the e-channel data; and
generating analytic reports on the e-channel data based on the analytics.

2. The method of claim 1, further comprising using the analytics for obtaining a rule based personalized website.

3. The method of claim 1, further comprising storing the e-channel data.

4. The method of claim 1, wherein the e-channel data comprises at least one of a web log data, application log data, user registration data and financial data.

5. The method of claim 4, wherein the user registration data comprises personal data of a visitor.

6. The method of claim 5, wherein the personal data of the visitor comprises at least one of age, gender, job and geographical area.

7. The method of claim 4, wherein the financial data comprises at least one of sales data and transaction data.

8. The method of claim 1, wherein the pre-processing of the e-channel data comprises:
using a visitor identifier for reconstructing a visit session and visit history;
eliminating multiple records from the reconstructed visit session and visit history, for an individual page hit;
identifying the visit session from the individual page hit information;
eliminating noise data occurring in the visit session and producing an output; and
reconstructing visit data using the output from the eliminated noise data and website domain knowledge.

9. The method of claim 8, wherein the visitor identifier comprises at least one of a TCP/IP address of a visitor in a web log, a cookie and a user login.

10. The method of claim 8, wherein the identifying of the visit session comprises:
using session identification algorithms to reconstruct the visit session from web log data; and
using time difference of two consequent page visits for calculating the duration of the visit.

11. The method of claim 1, wherein the performing of analytics on the e-channel data comprises:
identifying broken links in the website to increase website quality.

12. The method of claim 11, wherein identifying broken links comprises:
pre-processing web log data to identify a plurality of visit sessions;
filtering the plurality of visit sessions having broken links to obtain a filtered output;
applying sequential discovery to the filtered output to find a common path leading to the broken link;
identifying previous pages having the broken link;
checking links for the identified pages; and
fixing the broken link.

13. The method of claim 1, wherein the performing of analytics on the e-channel data comprises discovering preferences of a visitor and visitor profiling.

14. The method of claim 1, wherein the reports comprise at least one of a web usage report, customer profiling report and visitor navigation report.

15. The method of claim 14, wherein the web usage report comprises at least one of a daily usage summary, hourly usage summary and requests to a directory.

16. The method of claim 2, wherein obtaining the rule based personalized website, comprises:
providing integrated data from a plurality of data sources;
extracting rules from the integrated data and dynamic visitor behavior;
transferring knowledge obtained from extracted rules to a rule based web engine; and
using the rule based web engine for delivering dynamic contents to visitors.

17. A method for applying analytics based on e-channel data for a website, comprising:
obtaining a plurality of e-channel data;
pre-processing the e-channel data;
integrating the e-channel data;
performing analytics on the e-channel data;
generating analytic reports on the e-channel data based on the analytics; and
using the analytics for obtaining a rule based personalized website.

18. The method of claim 17, wherein using the analytics for obtaining a rule based personalized website comprises:
providing integrated data from a plurality of data sources;
extracting rules from the integrated data and dynamic visitor behavior;
transferring knowledge obtained from extracted rules to a rule based web engine; and
using the rule based web engine for delivering dynamic contents to visitors.

19. A marketing association analysis tool for a website, comprising:
a pre-processing component for pre-processing a plurality of e-channel data;
an association rule discovery engine for generating an output, wherein the output comprises rules based on the pre-processed data; and
a post-processing component for applying a pre-determined criterion on the output of the association rule discovery engine for extracting useful rules.

20. A system for analyzing e-channel data for a website, comprising:
an e-channel data input source that obtains a plurality of e-channel data;
a pre-processing component that preprocess the e-channel data;
an integrating component that integrates the e-channel data;
an analytics component that performs analytics on the e-channel data; and
a report component that generates reports on the e-channel data based on the analytics.

21. The system of claim 20, further comprising a rule based personalized website that uses the analytics.

22. The system of claim 20, wherein the e-channel data comprises at least one of web log data, application log data, user registration data and financial data.

23. The system of claim 22, wherein the user registration data comprises personal data of a visitor.

24. The system of claim 22, wherein the financial data comprises at least one of sales data and transaction data.

25. The system of claim 20, wherein the pre-processing data component comprises:
a plurality of visitors' identifiers that reconstruct a visit session and visit history;
a multiple record elimination component that eliminates multiple records from the visit session for an individual page hit;
a visit session identification component that identifies a visit session using an output from the multiple record elimination component;
a noise data elimination component that eliminates noise data in the identified visit session; and
a data reconstruction component that reconstructs the data using an output from the noise data elimination step and in accordance with website domain knowledge.

26. The system of claim 25, wherein the visitor identifier comprises at least one of a TCP/IP address of a visitor in a web log, a cookie and a user login.

27. The system of claim 25, wherein the visit session identification component comprises:
a series of session identification algorithms that reconstruct the visit session from web log data and
a visit duration calculator that uses time difference of two consequent page visits to calculate the duration of the visit session.

28. The system of claim 20, wherein the report component generates at least one of a web usage report, a customer profiling report and a visitor navigation report.

29. The system of claim 28, wherein the web usage report comprises at least one of daily usage summary, hourly usage and requests to directory.

30. The system of claim 21, wherein the rule based personalized website comprises:
an integrated data component for integrating data from a plurality of data sources
an extracting component for extracting rules from the integrated data and dynamic visitor behavior;
a knowledge transfer component that transfers knowledge obtained from the extracting component to a rule based web engine; and
a delivering component that uses the rule based web engine to deliver dynamic contents to visitors.

31. The system of claim 20, further comprising a web data mart to store the e-channel data.

32. A system for applying analytics based on e-channel data for a website comprising:
an e-channel data input source that obtains a plurality of e-channel data;
a pre-processing component that preprocess the e-channel data;
an integrating component that integrates the e-channel data;
an analytics component that performs analytics on the e-channel data;
a report component that generates reports on the e-channel data based on the analytics; and
a rule based personalized website that uses the analytics.

33. A system for analyzing e-channel data for a website, comprising:
an e-channel data input source that obtains a plurality of e-channel data;
a marketing association analysis tool comprising a pre-processing component that pre-processes the e-channel data; an association rule discovery engine for generating an output, wherein the output comprises rules based on the pre-processed data; and a post-processing component for applying a predetermined criterion on the output of the association rule discovery engine for extracting useful rules; and
a decision support report component that generates reports using the useful rules extracted by the marketing association analysis tool.

34. A system for analyzing e-channel data for a website, comprising:
means for obtaining a plurality of e-channel data;
means for pre-processing the e-channel data;
means for integrating the e-channel data;
means for performing analytics on the e-channel data; and
means for generating reports on the e-channel data based on the analytics.

35. The system of claim 34, further comprising means for using the analytics for obtaining a rule based personalized website.

36. The system of claim 34, further comprising means for storing the e-channel data.

37. The system of claim 34, wherein the means for preprocessing the e-channel data comprise:
means for using a visitor identifier for reconstructing a visit session and visit history;
means for eliminating multiple records from the reconstructed visit session and visit history for an individual page hit;
means for identifying a visit session from the individual page hit information;
means for eliminating noise data occurring in the visit session and producing an output; and
means for reconstructing visit data using the output from the eliminated noise data and website domain knowledge.

38. The system of claim 37, wherein means for identifying a visit session comprise:
means for using session identification algorithms to reconstruct the session from web log data; and
means for using time difference of two consequent page visits for calculating duration of the visit.

39. The system of claim 35, wherein means for obtaining the rule based personalized website, comprise:
means for providing integrated data from a plurality of data sources;
means for extracting rules from the integrated data and dynamic visitor behavior;
means for transferring knowledge obtained from extracted rules to a rule based web engine; and
using the rule based web engine for delivering dynamic contents to visitors.

40. A system for applying analytics based on c-channel data for a website, comprising:
means for obtaining a plurality of e-channel data;
means for pre-processing the e-channel data;
means for integrating the e-channel data;
means for performing analytics on the e-channel data;
means for generating analytic reports on the e-channel data based on the analytics; and
means for using the analytics for obtaining a rule based personalized website.

41. A computer readable medium storing computer instructions for instructing a computer system to analyze e-channel data for a website, the computer instructions comprising:
obtaining a plurality of e-channel data;
pre-processing the e-channel data;
integrating the e-channel data;
performing analytics on the e-channel data; and
generating analytic reports on the e-channel data based on the analytics.

42. The computer readable medium of claim 41, further comprises instructions for using the analytics for obtaining a rule based personalized website.

43. The computer readable medium of claim 41 further comprises instructions for storing the e-channel data.

44. The computer readable medium of claim 41, wherein preprocessing the e-channel data comprises instructions for:
using a visitor identifier for reconstructing a visit session and visit history;
eliminating multiple records from the reconstructed visit session and visit history for an individual page hit;
identifying the visit session from the individual page hit information;
eliminating noise data occurring in the visit session and producing an output; and
reconstructing visit data using the output from the eliminated noise data and website domain knowledge.

45. The computer readable medium of claim 44, wherein identifying the visit session comprises instructions for:
using session identification algorithms to reconstruct the session from web log data; and
using time difference of two consequent page visits for calculating the duration of the visit.

46. The computer readable medium of claim 41, wherein performing analytics on the e-channel data comprises instructions for:
identifying broken links in the website to increase website quality.

47. The computer readable medium of claim 46, wherein identifying broken links comprises instructions for:
pre-processing web log data to identify a plurality of visit sessions;
filtering the plurality of visit sessions having broken pages to obtain a filtered output;
applying sequential discovery to the filtered output to find a common path leading to the broken link;
identifying previous pages having the broken link;
checking links for the identified pages; and
fixing the broken link.

48. The computer readable medium of claim 41, wherein performing analytics on the e-channel data comprises instructions for discovering preferences of a visitor and visitor profiling.

49. The computer readable medium of claim 41, wherein the analytic reports on the e-channel data, comprise at least one of a web usage report, customer profiling report and visitor navigation report.

50. The computer readable medium of claim 49, wherein the web usage report comprises at least one of a daily usage summary, hourly usage and requests to a directory.

51. The computer readable medium of claim 42, wherein obtaining the rule based personalized website comprises instructions for:
providing integrated data from a plurality of data sources;
extracting rules from the integrated data and dynamic visitor behavior;
transferring knowledge obtained from extracted rules to a rule based web engine; and
using the rule based web engine for delivering dynamic contents to visitors.

52. A computer readable medium storing computer instructions for instructing a computer system to apply analytics based on e-channel data for a website, the computer instructions comprising:
obtaining a plurality of e-channel data;
pre-processing the e-channel data;
integrating the e-channel data;
performing analytics on the e-channel data;
generating analytic reports on the e-channel data based on the analytics; and
using the analytics for obtaining a rule based personalized website.
